(19) United States
(12) Patent Application Publication
(10) Pub. No.: US 2017/0263156 A1
(43) Pub. Date: Sep. 14, 2017

(54) METHOD AND SYSTEM FOR RECOMMENDING A SET OF INSULIN DOSAGES FOR A PATIENT

(71) Applicant: Quattro Folia Oy, Espoo (FI)

(72) Inventors: Pekka Lönnroth, Espoo (FI); Ari Sinisalo, Helsinki (FI); Harri Okkonen, Espoo (FI); Petteri Väisänen, Tampere (FI); Paulus Carpelan, Helsinki (FI)

(73) Assignee: Quattro Folia Oy, Espoo (FI)

(21) Appl. No.: 15/063,893

(22) Filed: Mar. 8, 2016

(51) Int. Cl. G09B 23/28; G08B 5/36; G08B 3/00; G06F 19/00

(52) U.S. Cl. CPC G09B 23/28; G06F 19/3418; G08B 5/36; G08B 3/00

(57) ABSTRACT

Disclosed is a method and system for recommending a set of insulin dosages for a patient. The method estimates a blood glucose level of the patient using a physiological glucose-insulin module based on a set of patient-related information. Thereafter, an insulin dosage calculator calculates the set of insulin dosages based on an output of the physiological glucose-insulin module and contextual information associated with the patient. Finally, the set of insulin dosages are presented to the patient.

### FIELD OF THE PRESENT INVENTION

The present invention generally relates to the field of diabetes management. More specifically, the present invention relates to a system and method for recommending a set of insulin dosages based on a set of patient-related information and context information associated with the patient.

### BACKGROUND OF THE PRESENT INVENTION

A patient with diabetes has a continuous challenge to estimate required insulin dosage at different instants of time. Various factors may affect the estimation of the required insulin dosage at a particular instant of time for a patient. Current blood glucose level, food eaten just before or after an insulin dosage, insulin remaining in the body from previous dosages, physical activity, stress, etc. are some of the factors that affect the estimation of the required insulin dosage at a particular instant of time. In addition to the current situation and immediate activities, upcoming events/activities and the patient's behavior also impacts the blood glucose level of the patient. Similarly, there could be instances where scheduled activities/events may get rescheduled/cancelled based on external factors directly/indirectly associated with the patient.

Accordingly, various factors such as blood glucose levels, meal plan, activities/events plans, the patient's behavior and various factors impacting the activities/events of patients are ought to be taken into account while estimating insulin dosages.

Therefore, there is a need for a method and system that can recommend a set of insulin dosages for a patient for a period of 24 hours based on various factors and uncertainties associated with them.

### BRIEF DESCRIPTION OF DRAWINGS

The accompanying figures wherein like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a bock diagram of a system for recommending a set of insulin dosages for a patient in accordance with an embodiment of the invention.

FIG. 2 illustrates a flow diagram of a method for recommending a set of insulin dosages for a patient in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PRESENT INVENTION

Before describing in detail embodiments that are in accordance with the present invention, it should be observed that the embodiments reside primarily in a method and system for recommending a set of insulin dosages to a patient based on a plurality of insulin dosage calculations. Accordingly, the method steps and system components have been represented where appropriate by conventional symbols in the drawings, showing only those specific details that are pertinent to understanding the embodiments of the present application so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of objects may include not only those objects but also include other objects not expressly listed or inherent to such process, method, article, or apparatus. An object proceeded by “comprises . . . a” does not, without more constraints, preclude the existence of additional identical objects in the process, method, article, or apparatus that comprises the object.

Generally speaking, pursuant to various embodiments, the present invention provides a method and system for recommending a set of insulin dosages to a patient. The system continuously estimates a blood glucose level of the patient using a physiological glucose-insulin module based on a set of patient-related information. Thereafter, a set of insulin dosages is calculated based on an output of the physiological glucose-insulin module and contextual information associated with the patient. The set of insulin dosages includes one or more of a basal insulin, bolus insulin and correction insulin. Finally, the set of insulin dosages for the patient are presented by the system.

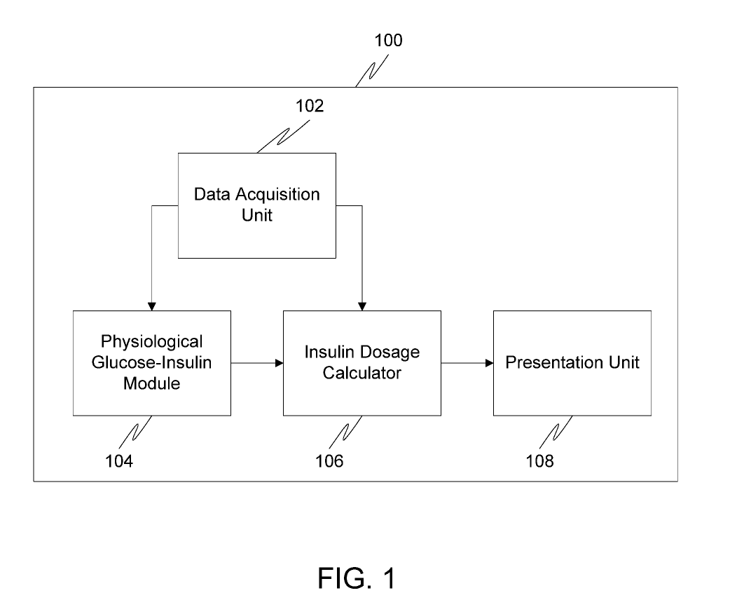

FIG. 1 illustrates a system 100 for recommending a set of insulin dosages for a patient in accordance with an embodiment of the invention. As illustrated in FIG. 1, system 100 includes a data acquisition unit 102 which is configured to acquire patient-related information. The patient related information includes one or more of self-monitor blood glucose (SMBG) values, a meal plan and an activity plan. Data acquisition unit 102 may acquire patient-related information from one or more of the patient, calendar applications and social networks associated with the patient. Data acquisition unit 102 is further configured to obtain contextual information associated with the patient. The contextual information includes one or more general health details, historical daily routine associated the patient, a stress level, an activity plan of the patient's social network connections, weather forecast for places relevant to the patient and presence of allergens in the places relevant to the patient.

In accordance with an embodiment, data acquisition unit 102 can be one of, but not limited to, a mobile phone, a smartphone, a portable device, a tablet device, a laptop and a desktop computer configured to collect patient-related information and contextual information associated with the patient. Further, data acquisition unit 102 may also be configured to interact with one or more sensors attached to one or more portions of the body of the patient. The one or more sensors may include one or more of, but not limited to, a glucose sensor, a glucose meter, a step meter, an activity meter, a heart rate meter, a calorie estimator, a thermometer and a stress meter.

The system also includes a physiological glucose-insulin module 104 which is configured to continuously estimate a blood glucose level of the patient. The blood glucose level of the patient is estimated based on the patient-related information as obtained by data acquisition unit 102.

Data acquisition unit 102 and physiological glucose-insulin module 104 are communicatively coupled for exchanging the patient-related information. The arrangement as illustrated in FIG. 1 is only for exemplary purposes and it will be evident to the person skilled in the art that data acquisition unit 102 and physiological glucose-insulin module 104 may be part of separate units. Similarly, physiological glucose-insulin module 104 may be implemented as cloud based solution. Therefore, all other possible arrangements are within the scope of the present invention. The patient-related information may be transmitted using a short-range communication that may be one or more of, but not limited to, Bluetooth network, Near Field Communication (NFC) network, Zig Bee network, Wi-Fi network, IR communication, modulated LED or laser communication, acoustical communication or wired communication.

In an embodiment, physiological glucose-insulin module 104 is based on an artificial intelligence system. The artificial intelligence system includes one or more of a back propagation artificial neural network, fuzzy logic system, and combination of the back propagation artificial network and fuzzy logic system forming a hybrid intelligent system (‘Neuro-Fuzzy’). In an embodiment, physiological glucose-insulin module 104 may be used with population average parameters or with specifically personalized/defined parameters for the patient.

Moving on, an insulin dosage calculator 106 is employed to calculate a set of insulin dosages for the next 24 hours. The set of insulin dosages are calculated based on the contextual information associated with the patient obtained from data acquisition unit 102 and an output obtained from physiological glucose-insulin module 104.

In an embodiment, insulin dosage calculator 106 uses a heuristic search algorithm for calculating the set of insulin dosages. In an exemplary embodiment, the heuristic search algorithm is a Monte Carlo Tree Search (MCTS) algorithm. In another exemplary embodiment, the heuristic search algorithm is a genetic algorithm. In yet another exemplary embodiment, the heuristic search algorithm is a combination of the MCTS and the genetic algorithm.

Accordingly, using the contextual information such as general health details, historical daily routine associated the patient, a stress level, an activity plan of the patient's social network connections, weather forecast for places relevant to the patient and presence of allergens in the places relevant to the patient, and the output of physiological glucose-insulin module 104, the heuristic search algorithm perform simulations to estimate a set of insulin dosages.

Thereafter, a presentation unit 108 presents the set of insulin dosages to the patient. In an embodiment, the set of insulin dosages are displayed to the patient. In another embodiment, the set of insulin dosages are rendered as one of an audio message, a visual message and an audiovisual message to the patient.

In yet another embodiment, the set of insulin dosages are transmitted to an administering unit configured to administer the insulin dosage to the patient. It will be apparent to the person skilled in the art that system 100 and the administering unit may communicate with each other using any appropriate communication medium.

Once the patient receives the recommendation for the set of insulin dosages, the patient may follow the recommendation or may adjust the set of dosages before actual insulin administration. Insulin administration includes all means of drug delivery including, but not limited to injections, insulin pump, powder inhale, liquid spray inhale, swallow, and transfer through the skin. The patient may be required to adjust the set of insulin dosages based on one or more of an actual meal consumed by the patient, an actual activity performed by the patient in the day, and actual events occurred in the day. Since, system 100 estimates the set of insulin dosages based on potential plans of the patient, the set of insulin dosages may be required to adjust based on any deviation to the plans of the patient.

Thereafter, data acquisition unit 102 acquires the actual meal consumed by the patient, the actual activity performed by the patient in the day, and the actual events occurred in the day along with the actual insulin administrations by the patient. Data acquisition unit 102 stores the acquired data in a daily routine database associated with the patient.

In order to further refine the recommendations of the set of insulin dosages, insulin dosage calculator 106 uses at least a part of data from the daily routine database. Therefore, system 100 keeps improving insulin dosage calculator 106 by using ever increasing historical routine data.

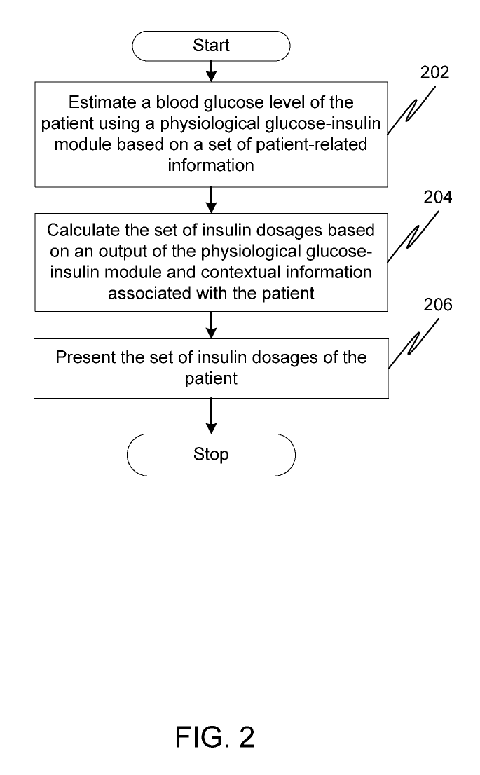

Moving on, FIG. 2 illustrates a flow diagram of a method for recommending a set of insulin dosages for a patient in accordance with an embodiment of the invention.

To begin the process, data acquisition unit 102 acquires a set of patient-related information and contextual information associated with the patient. The set of patient-related information is provided to physiological glucose-insulin module 104. Accordingly, at step 202, physiological glucose-insulin module 104 continuously estimates a blood glucose level of the patient using the set of patient-related information.

Thereafter, at step 204, the set of insulin dosages are calculated based on an output of physiological glucose-insulin module 104 and contextual information associated with the patient. In an embodiment, insulin dosage calculator 106 uses a heuristic search algorithm for calculating the set of insulin dosages. In an exemplary embodiment, the heuristic search algorithm is a Monte Carlo Tree Search (MCTS) algorithm. In another exemplary embodiment, the heuristic search algorithm is a genetic algorithm. In yet another exemplary embodiment, the heuristic search algorithm is a combination of the MCTS and the genetic algorithm.

Accordingly, using the contextual information such as general health details, historical daily routine associated the patient, a stress level, an activity plan of the patient's social network connections, weather forecast for places relevant to the patient and presence of allergens in the places relevant to the patient, and the output of physiological glucose-insulin module 104, the heuristic search algorithm perform simulations to estimate a set of insulin dosages.

Thereafter, at step 206, the set of insulin dosages are presented to the patient. In an embodiment, the set of insulin dosages are displayed to the patient. In another embodiment, the set of insulin dosages are rendered as one of an audio message, a visual message and an audiovisual message to the patient.

In yet another embodiment, the set of insulin dosages are transmitted to an administering unit configured to administer the insulin dosage to the patient.

Once the patient receives the recommendation for the set of insulin dosages, the patient may follow the recommendation or may potentially adjust the set of insulin dosages before actual insulin administration. The patient may require to adjust the set of insulin dosages based on one or more of an actual meal consumed by the patient, an actual activity performed by the patient in the day, and actual events occurred in the day.

Thereafter, data acquisition unit 102 acquires the actual meal consumed by the patient, the actual activity performed by the patient in the day, and the actual events occurred in the day along with the actual insulin administrations by the patient. Data acquisition unit 102 stores the acquired data in a daily routine database associated with the patient.

In order to further refine the recommendations of the set of insulin dosages, insulin dosage calculator 106 uses at least a part of data from the daily routine database. Therefore, system 100 keeps improving insulin dosage calculator 106 by using ever increasing historical routine data.

An embodiment of the present invention may relate to a computer program product with a non-transitory computer readable storage medium having computer code thereon for performing various computer-implemented operations of the method and/or system disclosed herein. The media and computer code may be those specially designed and constructed for the purposes of the method and/or system disclosed herein, or they may be of the kind well known and available to those having skill in the computer software arts. Examples of computer-readable media include, but are not limited to, magnetic media, optical media, magneto-optical media and hardware devices that are specially configured to store and execute program code. Examples of computer code include machine code, such as produced by a compiler, and files containing higher-level code that are executed by a computer using an interpreter. For example, an embodiment of the present invention may be implemented using JAVA®, C++, or other object-oriented programming language and development tools. Aspects of the present invention may also be implemented using Hypertext Transport Protocol (HTTP), Procedural Scripting Languages and the like.

The method and system disclosed herein recommends a set of insulin dosages for a patient for period of next 24 hours. The system includes a neural network based physiological glucose-insulin module that continuously estimates a blood glucose level of the patient based on patient-related information such as SMBG, a meal plan and an activity plan. The system further includes a heuristic search algorithm based insulin dosage calculator that estimates the set of insulin dosages based on the blood glucose level and contextual information associated with the patient. The method and system recommends an optimum set of insulin dosages that statistically closest to the best or is the best possible set of insulin dosages for the given patient-related information, blood glucose level and the contextual information associated with the patient. The system also provides an option to the patient to manually adjust the set of insulin dosages. The system keeps refining the calculation based on actual data obtained from the patient along with the actual (adjusted) set of insulin administrations by the patient.

Those skilled in the art will realize that the above-recognized advantages and other advantages described herein are merely exemplary and are not meant to be a complete rendering of all of the advantages of the various embodiments of the present invention. Additionally, embodiments need not achieve these, or another advantage, and should not be limited there to.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features, of the present invention.

What is claimed is:

1. A computer implemented method for recommending a set of insulin dosages for a patient, the computer implemented method comprising:
estimating a blood glucose level of the patient using a physiological glucose-insulin module, the physiological glucose-insulin module estimating the continuous blood glucose level based on a set of patient-related information;
calculating the set of insulin dosages using an insulin dosage calculator based on an output of the physiological glucose-insulin module and contextual information associated with the patient; and
presenting the set of insulin dosages for the patient.

2. The computer implemented method of claim 1, wherein the set of insulin dosages comprises at least one of a basal insulin, bolus insulin and correction insulin.

3. The computer implemented method of claim 1, wherein the patient-related information comprises at least one of Self-Monitor Blood Glucose (SMBG) values, a meal plan and an activity plan.

4. The computer implemented method of claim 1, wherein the contextual information associated with the patient comprises at least one of general health details, a stress level, an activity plan of the patient's social network connections, weather forecast, and presence of allergens.

5. The computer implemented method of claim 1, wherein at least one parameter of the physiological glucose-insulin module is automatically defined for each patient.

6. The computer implemented method of claim 1, wherein the insulin dosage calculator uses a heuristic search algorithm for calculating the set of insulin dosages, the heuristic search algorithm being one of a Monte Carlo Tree Search (MCTS), a genetic algorithm and a combination of the MCTS and the genetic algorithm.

7. The computer implemented method of claim 6 further comprising:
monitoring at least one of an actual meal consumed by the patient in a day, an actual activity performed by the patient in a day and actual events occurred in a day; and
storing the actual meal consumed by the patient in the day, the actual activity performed by the patient in the day, actual events occurred in the day and the set of insulin dosages recommended for the day in a daily routine database.

8. The computer implemented method of claim 7, wherein the insulin dosage calculator uses at least a part of data from the daily routine database to further refine calculation of the set of insulin dosages.

9. The computer implemented method of claim 1, wherein the physiological glucose-insulin module is based on an artificial intelligence system comprising at least one of a back propagation artificial neural network, fuzzy logic system, and combination of the back propagation artificial neural network and fuzzy logic system forming a hybrid intelligent system (‘Neuro-Fuzzy’).

10. The computer implemented method of claim 1, wherein the presenting the set of insulin dosages comprises at least one of:
displaying the set of insulin dosages to the patient; and
rendering the set of insulin dosages as one of an audio message, a visual message and an audiovisual message to the patient.

11. The computer implemented method of claim 1 further comprising transmitting the set of insulin dosages to an administering unit configured to administer the insulin dosage to the patient.

12. The computer implemented method of claim 1, wherein the set of insulin dosages is recommended for a period of 24 hours.

13. A system for recommending a set of insulin dosages for a patient, the system comprising:
a data acquisition unit, wherein the data acquisition unit is configured to acquire a set of patient-related information and contextual information with the patient; and
a physiological glucose-insulin module, wherein the physiological glucose-insulin module is configured to continuously estimate a blood glucose level of the patient based on the set of patient-related information;
an insulin dosage calculator, wherein the insulin dosage calculator is configured to calculate the set of insulin dosages based on an output of the physiological glucose-insulin module and the contextual information associated with the patient; and
a presentation unit configured to present the set of insulin dosages for the patient.

14. The system of claim 13, wherein the insulin dosage calculator uses a heuristic search algorithm for calculating the set of insulin dosages, the heuristic search algorithm being one of a Monte Carlo Tree Search (MCTS), a genetic algorithm and a combination of the MCTS and the genetic algorithm.

15. The system of claim 13, wherein the data acquisition unit is further configured to:
monitor at least one of an actual meal consumed by the patient in a day, an actual activity performed by the patient in a day and actual events occurred in a day; and
store the actual meal consumed by the patient in the day, the actual activity performed by the patient in the day, actual events occurred in the day and the set of insulin dosages recommended for the day in a daily routine database.

16. A non-transitory computer readable medium storing a computer program for causing a computing device to perform a method of recommending a set of insulin dosages for a patient, the method comprising;
estimating a blood glucose level of the patient using a physiological glucose-insulin module, the physiological glucose-insulin module estimating the continuous blood glucose level based on a set of patient-related information;
calculating the set of insulin dosages using an insulin dosage calculator based on an output of the physiological glucose-insulin module and contextual information associated with the patient; and
presenting the set of insulin dosages for the patient.
